(19) United States
(12) Patent Application Publication
(10) Pub. No.: US 2023/0259739 A1
(43) Pub. Date: Aug. 17, 2023

(54) IMAGE DETECTION METHOD AND APPARATUS, COMPUTER-READABLE STORAGE MEDIUM, AND COMPUTER DEVICE

(71) Applicant: TENCENT TECHNOLOGY (SHENZHEN) COMPANY LIMITED, SHENZHEN (CN)

(72) Inventors: Boshen ZHANG, Shenzhen (CN); Yabiao Wang, Shenzhen (CN); Chengjie Wang, Shenzhen (CN); Jilin Li, Shenzhen (CN); Feiyue Huang, Shenzhen (CN)

(73) Assignee: TENCENT TECHNOLOGY (SHENZHEN) COMPANY LIMITED, SHENZHEN (CN)

(21) Appl. No.: 18/302,265

(22) Filed: Apr. 18, 2023

Related U.S. Application Data
(63) Continuation of application No. PCT/CN2022/098383, filed on Jun. 13, 2022.

(30) Foreign Application Priority Data
Jul. 16, 2021 (CN) 202110804450.6

(51) Int. Cl. G06N 3/043; G06N 3/045

(52) U.S. Cl. CPC G06N 3/043; G06N 3/045

(57) ABSTRACT

Disclosed herein are an image detection method and apparatus, a computer-readable storage medium, and a computer device. The method includes iteratively training a plurality of neural network models to obtain a plurality of trained neural network model; and performing detection on an image to be detected using the trained plurality of neural network models to obtain a detection result. Each iteration of training includes: for each of a plurality of sample images, separately inputting the sample image into the neural network models to obtain a fuzzy probability value set, and calculating, based on the fuzzy probability value set and preset label information of the sample image, a loss parameter of the sample image; selecting target sample images based on a distribution of loss parameters of the plurality of sample images; and updating the plurality of neural network models based on the target sample images.

### CROSS REFERENCE TO RELATED APPLICATIONS

This application is a bypass continuation application of International Patent Application No. PCT/CN2022/098383, filed on Jun. 13, 2022, which is based on and claims priority to Chinese Patent Application No. 202110804450.6, filed on Jul. 16, 2021 with the China National Intellectual Property Administration, the disclosures of which are incorporated by reference herein in their entireties.

### FIELD

The present disclosure relates to the field of image processing, and in particular to an image detection method and apparatus, a computer-readable storage medium, and a computer device.

### BACKGROUND

Convolutional Neural Networks (CNNs) are a class of Feed Forward Neural Networks (FFNNs) that contain convolution calculation and have depth structure, and become one of the representative algorithms in Deep Learning (DL). CNNs have the capability of Representation Learning (RL) and are able to perform shift invariant classification on the input information according to the hierarchical structure, so they are also called “Shift-Invariant Artificial Neural Networks (SIANNs)”.

In recent years, CNN-related technologies have developed rapidly and been widely used. For example, in a scenario where blur detection is performed for an image, the efficiency of the blur detection for the image may be improved by constructing an image detection model using a CNN.

However, in a current image detection model constructed using a CNN, the label of a training sample image used at the model training stage is a simple binary label, and an inaccurate binary label will affect the performance of the trained model, and further lead to low accuracy of image detection.

### SUMMARY

In accordance with certain embodiments of the present disclosure, an image detection method performed by a computer device is provided, and includes: iteratively training a plurality of neural network models until the plurality of neural network models converge, to obtain a plurality of trained neural network models; and performing fuzzy detection on an image to be detected by at least one trained neural network model of the plurality of trained neural network models, to obtain a fuzzy detection result. Each iteration of training may include: for each sample image in a plurality of sample images corresponding to the iteration, separately inputting the sample image into the plurality of neural network models, to obtain a fuzzy probability value set of the sample image, the fuzzy probability value set comprising fuzzy probability values outputted from each of the plurality of neural network models, and calculating, based on the fuzzy probability value set and preset label information of the sample image, a loss parameter of the sample image; selecting, based on a distribution of loss parameters of the plurality of sample images, target sample images from the plurality of sample images; and updating, based on the target sample images, the plurality of neural network models.

In accordance with other embodiments of the present disclosure, an image detection method apparatus is provided, and includes at least one processor and at least one non-volatile memory having stored thereon a plurality of neural network models and a computer program. The computer program, when executed by the at least one processor, may cause the at least one processor to perform operations of: iteratively training a plurality of neural network models until the plurality of neural network models converge, to obtain a plurality of trained neural network models; and performing fuzzy detection on an image to be detected by at least one trained neural network model of the plurality of trained neural network models, to obtain a fuzzy detection result. Each iteration of training may include: for each sample image in a plurality of sample images corresponding to the iteration, separately inputting the sample image into the plurality of neural network models, to obtain a fuzzy probability value set of the sample image, the fuzzy probability value set comprising fuzzy probability values outputted from each of the plurality of neural network models, and calculating, based on the fuzzy probability value set and preset label information of the sample image, a loss parameter of the sample image; selecting, based on a distribution of loss parameters of the plurality of sample images, target sample images from the plurality of sample images; and updating, based on the target sample images, the plurality of neural network models.

In accordance with still other embodiments of the present disclosure, a non-transitory computer-readable storage medium storing a plurality of instructions thereon is provided. The instructions may be executable by at least one processor to perform operations of an image detection method, which includes: iteratively training a plurality of neural network models until the plurality of neural network models converge, to obtain a plurality of trained neural network models; and performing fuzzy detection on an image to be detected by at least one trained neural network model of the plurality of trained neural network models, to obtain a fuzzy detection result. Each iteration of training may include: for each sample image in a plurality of sample images corresponding to the iteration, separately inputting the sample image into the plurality of neural network models, to obtain a fuzzy probability value set of the sample image, the fuzzy probability value set comprising fuzzy probability values outputted from each of the plurality of neural network models, and calculating, based on the fuzzy probability value set and preset label information of the sample image, a loss parameter of the sample image; selecting, based on a distribution of loss parameters of the plurality of sample images, target sample images from the plurality of sample images; and updating, based on the target sample images, the plurality of neural network models.

These and other embodiments of the disclosure provide an image detection scheme improving the effect of model training by screening noise samples in training samples with multi-model collaboration, thereby improving the accuracy rate of image detection.

### BRIEF DESCRIPTION OF THE DRAWINGS

In order to illustrate more clearly the technical solutions in embodiments of the present disclosure, a brief introduction will be given to the accompanying drawings which are required in the description of the embodiments. It is noted that the drawings described below are merely certain embodiments of the present disclosure, and that a person of skill in the art can obtain other drawings according to these drawings without involving any inventive effort.

FIG. 1 is a schematic diagram showing a training scenario of image detection models according to an embodiment of the disclosure;

FIG. 2 is a schematic flowchart of an image detection method according to an embodiment of the disclosure;

FIG. 3 is schematic flowchart of another image detection method according to an embodiment of the disclosure;

FIG. 4 is a schematic diagram of a loss parameter calculation framework of sample images according to an embodiment of the disclosure;

FIG. 5 is a structural schematic diagram of an image detection apparatus according to an embodiment of the disclosure;

FIG. 6 is a structural schematic diagram of a terminal according to an embodiment of the disclosure; and

FIG. 7 is a structural schematic diagram of a server according to an embodiment of the disclosure.

### DETAILED DESCRIPTION

The technical solutions in embodiments of the present disclosure will now be described clearly and fully hereinafter with reference to various drawings. The embodiments described and illustrated herein discuss some but not all embodiments of the present disclosure. Based on the embodiments disclosed herein, all other embodiments obtained by a person of skill in the art without inventive effort shall fall within the protection scope of the present disclosure.

The embodiments of the present disclosure provide an image detection method and apparatus, a non-transitory computer-readable storage medium, and a computer device. The image detection method may be used in the image detection apparatus. The image detection apparatus may be integrated into the computer device, which may be a terminal or a server. The terminal may be a mobile phone, a tablet computer, a laptop, a smart TV, a wearable smart device, a personal computer (PC), and the like. The server may be an independent physical server, a server cluster or distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The plurality of servers may form a block chain, and the servers are nodes of the block chain.

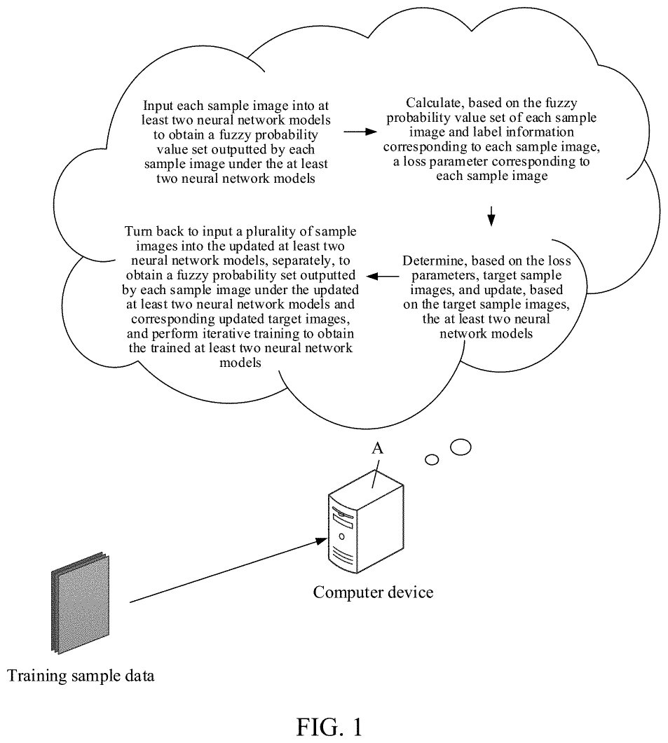

FIG. 1 is a schematic diagram showing a training scenario of image detection models according to an embodiment of the disclosure. Computer device A may perform various methods and operations according to embodiments of the disclosure, which may include:

Operation A: For each sample image in a first plurality of sample images,

input the sample image into at least two neural network models (that is, a plurality of neural network models), separately, to obtain a fuzzy probability value set of the sample image, the fuzzy probability value set including fuzzy probability values outputted from each of the at least two neural network models;

calculate, based on the fuzzy probability value set and preset label information of the sample image, a loss parameter of the sample image;

Operation B: Select, based on a distribution of loss parameters of the plurality of sample images, target sample images from the plurality of sample images, and update, based on the target sample images, the at least two neural network models to obtain the updated at least two neural network models;

perform, by utilizing at least two second pluralities of sample images, the Operation A and Operation B above successively on the updated at least two neural network models until the at least two neural network models converge to obtain the trained at least two neural network models; and

provide at least one neural network model of the trained at least two neural network models for performing fuzzy detection on an image to be detected to obtain a fuzzy detection result.

The first plurality of sample images and the second plurality of sample images may share some or all images, or may have completely different images from each other.

In an example embodiment, after acquiring training sample data, the computer device A extracts a plurality of sample images and fuzzy label values corresponding to each of the sample images from the training sample data. Then each extracted sample image is inputted into at least two neural network models for detection, to obtain a fuzzy probability value set outputted by each sample image under the at least two neural network models. A loss parameter corresponding to each sample image is calculated based on the fuzzy probability value set of each sample image and label information corresponding to each sample image. Target sample images are determined based on the loss parameters, and the at least two neural network models are updated based on these target sample images to obtain the updated at least two neural network models. Execution turns back to input the plurality of sample images into the updated at least two neural network models, separately, to obtain a fuzzy probability value set outputted by each sample image under the updated at least two neural network models and corresponding updated target images, and iterative training is performed until parameters of the at least two neural network models converge to obtain the trained at least two neural network models. In this way, training on the neural network models for image detection according to an embodiment of the disclosure is completed. After the models are trained, an image to be detected which requires fuzzy detection can be input to the trained at least two neural network models to obtain an image detection result of the image to be detected.

The schematic diagram showing the training scenario of the image detection models shown in FIG. 1 is merely an example, and the training scenario of the image detection models described herein is provided to illustrate the technical solutions of the disclosure more clearly and does not constitute a limitation on the technical solutions provided in the disclosure. It is to be understood by a person of ordinary skill in the art that with the evolution of image detection model training and the emergence of new service scenarios, the technical solutions provided in the disclosure are also applicable to similar technical problems.

Detailed descriptions are given below based on the above implementation scenarios.

Embodiments of the disclosure will be described in the context of an image detection apparatus that may be integrated into a computer device. The computer device may be a terminal or a server, and the terminal may be a mobile phone, a tablet computer, a laptop, a smart TV, a wearable smart device, a personal computer (PC), and the like.

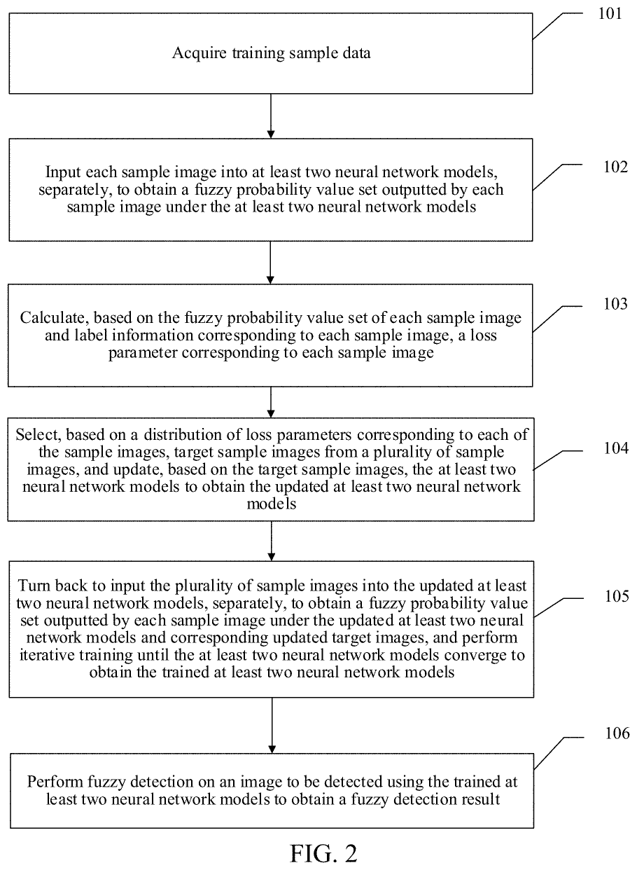

FIG. 2 shows a schematic flowchart of an image detection method according to an embodiment of the disclosure, the method including:

Operation 101: Acquire training sample data.

In a scenario for evaluating quality of an image or a video, the quality of the image or the video is often evaluated by determining whether there is a blur in the image or each image frame of the video. Image blur means that the image content is difficult to distinguish due to the fuzzy phenomenon in the image. The phenomenon is similar to the abnormality of a displayed image when a blur occurs on the computer screen, so it is called image blur.

In the related art, it is generally determined by human eyes whether an image is a blurred image. However, due to the low efficiency of human eye determination, a method is proposed of using machine learning technology to detect a blurred image. Machine Learning (ML) is a multi-field interdisciplinary subject, involving probability theory, statistics, approximation theory, convex analysis, algorithmic complexity theory, and other disciplines. It focuses on how computers simulate or implement human learning behaviors to acquire new knowledge or skills and reorganize the existing knowledge structure to continuously improve the performance. ML is the core of artificial intelligence and the fundamental way to impart computer intelligence, which is applied in various fields of artificial intelligence. Techniques for ML and DL generally include artificial neural networks, belief networks, reinforcement learning, transfer learning, inductive learning, teaching learning, and other technologies.

ML technology may be used to perform blur detection for an image. CNN models can be used for detection. Specifically, labeled training images can be inputted into a CNN to train the CNN, then the image to be identified is inputted into the trained CNN model for feature extraction, and then classification is performed via a fully-connected layer to obtain a detection result. The label information of images is binary label information marked manually. That is, the label information of images is any of two labels, namely, being blurred or not blurred. However, a blurred image does not simply fall within a binary classification. Many blurred images are only slightly blurred or partially blurred. There will be much subjectivity if an image is simply determined to be blurred or not blurred, so that the manually marked labels will be inaccurate, and thus the detection performance of the trained neural network models will decrease, resulting in that the image detection results are inaccurate.

In order to solve the above technical problem that the image detection results of the trained models are inaccurate due to the inaccurate manually marked labels, an image detection method according to an embodiment of the disclosure is described in further detail below.

In certain embodiments of the disclosure, acquired sample data may be used to train the detection models. The sample data may be stored on a block chain. The sample data includes a plurality of sample images and label information corresponding to each of the sample images. The label information corresponding to a sample image is a binary label of the sample, namely, the sample image is blurred or not blurred. As described above, the binary labels of the sample images are manually marked. In view of subjectivity of manual marking, the label information of the sample images contains some noise, that is, some of the labels are inaccurate.

Operation 102: Input each sample image into at least two neural network models, separately, to obtain a fuzzy probability value set outputted by each sample image under the at least two neural network models.

In certain embodiments of the disclosure, a plurality of neural network models are used for collaborative training. The plurality herein refers to at least two neural network models. The neural network models herein may also be CNN models of any structure. The at least two neural network models may be untrained neural network models or may be pre-trained artificial neural network models.

A plurality of sample images contained in the sample data are input one by one to the at least two neural network models for fuzzy detection. The fuzzy detection is to detect a fuzzy probability of the images, or to detect a blur probability of the images. Therefore, the corresponding output results are the fuzzy probability values of the images, and the fuzzy probability values of the images herein are probability values of image blur. It is to be understood that, for any target sample image, inputting into the at least two neural network models results in fuzzy probability values outputted from each of the neural network models, and therefore at least two fuzzy probability values corresponding to the target sample image are obtained, and the at least two fuzzy probability values constitute a fuzzy probability value set corresponding to the target sample image. Likewise, for other sample images, inputting into the at least two neural network models results in a fuzzy probability value set outputted from the at least two neural network models as well, thereby obtaining a fuzzy probability value set corresponding to each sample image.

Operation 103: Calculate, based on the fuzzy probability value set of each sample image and label information corresponding to each sample image, a loss parameter corresponding to each sample image.

After a fuzzy probability value set of each sample image is calculated, the loss parameter corresponding to each sample image is calculated based on the fuzzy probability value set and label information corresponding to each sample image. The loss parameter herein is a parameter for evaluating the differential between the label value of the sample image and the output results of the models. As the models are constantly updated over the training process, the loss parameter corresponding to the sample image will gradually decrease, that is, the output results of the models will constantly approach the label value of the sample image. In certain embodiments of the disclosure, multi-model collaboration is used for training, and as such the loss parameter herein is a parameter for evaluating the differential between the integrated result of the output results of multiple models and the label value of the sample image. The loss parameter may more specifically be a sum of a plurality of differentials between the label value of the sample image and the output values of each of the models. For example, when the label value of the sample image is 1 (that is, the sample image is a blurry image), the number of neural network models used for collaborative training is 2, and the separate fuzzy probability values obtained by the two neural network models detecting the sample image are 0.95 and 0.98, the loss parameter may be (1−0.95)+(1−0.98)=0.07.

In certain embodiments, the calculating, based on the fuzzy probability value set of each sample image and label information corresponding to each sample image, a loss parameter corresponding to each sample image includes:

1: calculating first cross entropies between each of fuzzy probability values in the fuzzy probability value set corresponding to each sample image and corresponding label information;

2: summing the calculated first cross entropies to obtain a first sub-loss parameter corresponding to each sample image; and

3: determining the loss parameter corresponding to each sample image based on the first sub-loss parameter corresponding to each sample image.

In certain embodiments of the disclosure, loss parameters corresponding to sample images can be determined based on cross entropies between a probability value sequence composed of elements in fuzzy probability value sets corresponding to each of the sample images and a label sequence composed of labels of the sample images. The label sequence composed of labels of the sample images is a numerical sequence composed of label values of a plurality of sample images, where the number of numerical values in the numerical sequence is the number of at least two neural network models. For example, when the number of neural network models used for collaborative training is 5 and the label value of the target sample image is 1, the label sequence is {1, 1, 1, 1, 1}.

Cross Entropy (CE) is an important idea in information theory, which is mainly used to measure the differential information between two probability distributions. The cross entropy can be used as a loss function in a neural network to measure the similarity between the predicted distribution of the model and the real distribution of the sample. One advantage of the cross entropy acting as a loss function is that the problem of low learning speed of the mean square error loss function can be avoided as the gradient decreases, thereby improving the efficiency of model training.

After calculating the cross entropies between the plurality of fuzzy probability values corresponding to any target sample image and the corresponding label information, a plurality of cross entropies corresponding to the target sample image are obtained. Then, the plurality of cross entropies corresponding to the target sample image are summed to obtain the first sub-loss parameter corresponding to the target sample image, which is determined as the loss parameter of the target sample image. Then, the loss parameters corresponding to each of the sample images can be further determined according to the method described above.

In certain embodiments, the image detection method may further include:

A: calculating relative entropies between each pair of fuzzy probability values in the fuzzy probability value set corresponding to each sample image;

B: summing the relative entropies to obtain a second sub-loss parameter corresponding to each sample image; and

C: determining a loss parameter corresponding to each sample image based on a first sub-loss parameter corresponding to each sample image, including:

performing weighted summation on the first sub-loss parameter and the second sub-loss parameter corresponding to each sample image to obtain the loss parameter corresponding to each sample image.

In certain embodiments of the disclosure, the relative entropies between fuzzy probability values outputted by the same sample image under different models may be further calculated. A Relative Entropy (RE), also known as Kullback-Leibler Divergence (KL Divergence) or Information Divergence (ID), is an asymmetry measure of the difference between two probability distributions. In such manner, a relative entropy may be calculated for each possible pair of fuzzy probability values. When the number of neural network models used for collaborative training is 2, there is one relative entropy corresponding to the sample image. When the number of neural network models used for collaborative training is 3, there are 3 relative entropies corresponding to the sample image. When the number of neural network models used for collaborative training is n, there are n*(n−1)/2 relative entropies corresponding to the sample image. After all the relative entropies corresponding to the sample image are calculated, the values of these relative entropies are summed to obtain the second sub-loss parameter corresponding to the sample image. Further, weighted summation is performed on the first sub-loss parameter and the second sub-loss parameter above to obtain the loss parameter corresponding to the sample image, and then the loss parameters corresponding to each of the sample images can be further determined. The relative entropies of the output values of the same sample image in different neural network models are added to the loss parameter of the sample image, so that the outputs of different neural network models approach each other constantly during model training, thereby improving the accuracy of model training.

In some embodiments, the method further includes:

a: acquiring probability distribution information of label information in sample data, and generate a corresponding feature vector based on the probability distribution information;

b: calculating second cross entropies between the feature vector and the fuzzy probability value set corresponding to each sample image;

c: summing the calculated second cross entropies to obtain a third sub-loss parameter corresponding to each sample image; and

d: performing weighted summation on the first sub-loss parameter and the second sub-loss parameter corresponding to each sample image to obtain the loss parameter corresponding to each sample image, including:

performing weighted summation on the first sub-loss parameter, the second sub-loss parameter, and the third sub-loss parameter corresponding to each sample image to obtain the loss parameter corresponding to each sample image.

In certain embodiments of the disclosure, label information of a plurality of sample images can be determined first, and then the probability distribution information of the label information in the sample data is acquired based on the label information of the plurality of sample images. For example, when the number of sample images is 10, where the number of samples with a label of 1 is 5 and the number of samples with a label of 0 is 5, the probability distribution of the label information in the sample data can be determined to be [0.5, 0.5]. Further, a corresponding feature vector can be generated based on the probability distribution information so as to perform the calculation of cross entropies. Further, the cross entropies between the probability distribution and the fuzzy probability value set corresponding to each sample image can be calculated, and then the obtained cross entropies are summed to obtain the third sub-loss parameter corresponding to each sample image. Further, weighted summation may be performed on the first sub-loss parameter, the second sub-loss parameter, and the third sub-loss parameter above to obtain the loss parameter corresponding to each sample image.

The above are only instances of some embodiments. In other embodiments, any one or any combination of the first sub-loss parameter, the second sub-loss parameter, and the third sub-loss parameter may be utilized. For example, the first sub-loss parameter, the second sub-loss parameter, or the third sub-loss parameter may be used alone as the loss parameter corresponding to the sample image. As another example, weighted summation may be performed on the first sub-loss parameter and the third sub-loss parameter to obtain the loss parameter corresponding to the sample image.

Operation 104: Select, based on a distribution of loss parameters corresponding to each of the sample images, target sample images from the plurality of sample images, and update, based on the target sample images, the at least two neural network models to obtain the updated at least two neural network models.

After the loss parameters corresponding to each of the sample images are calculated, a certain number of target sample images with small loss parameter values are selected from the sample images based on the distribution of the loss parameters corresponding to the sample images. Then, the at least two neural network models are trained by using the certain number of target sample images, and the original at least two neural network models are updated by using the trained at least two neural network models, so as to obtain the updated at least two neural network models. A sample image having a smaller loss parameter value may have a closer output value obtained through model detection to the label of the sample image, and a more accurate label value. A sample image having a greater loss parameter value may have a less accurate label value. Therefore, some sample images with great loss parameter values can be eliminated from the sample images, so that the label values of the remaining sample images are more accurate, so that the trained models have higher detection accuracy.

In some embodiments, target sample images are selected from a plurality of sample images based on the distribution of loss parameters corresponding to each of the sample images, including:

1: acquiring a number of times of iterative training on the at least two neural network models;

2: calculating a target number of the target sample images based on the number of times of iterative training; and

3: selecting the target number of sample images in an order of loss parameters being from small to great to obtain the target sample images.

A certain number of target sample images are determined in the plurality of sample images, and after the at least two neural network models are trained and updated based on the target sample images, each sample image is detected again using the updated at least two neural network models to obtain a fuzzy probability value set corresponding to each sample image. New loss parameter values are then calculated for each of the sample images based on the new fuzzy probability value sets and the label values of each of the sample images. Target sample images are re-determined based on the new loss parameter values. The updated at least two neural network models are re-trained and updated based on the new target sample images, such that the at least two neural network models are iteratively trained for multiple times.

In certain embodiments of the disclosure, the number of the target sample images determined during each iteration of the iterative training on the at least two neural network models is related to the number of times of iteration of the model training. That is, the number of the target sample images is different in each cycle or iteration of iterative training of the models. A greater number of iterations may means that fewer sample images are used, so that in the process of continuous iterative training, training samples with less accurate label values are gradually eliminated. Therefore, every time target sample images are determined, the current number of iterations of training on the at least two neural network models may be acquired first. For example, a fifth training on the at least two neural network models determines that the number of times of iterative training is 5. The target number of the target sample images to be preserved is then calculated based on the number of times of training. Finally, the target number of sample images are selected in an order of loss parameters of each of the sample images being from small to great to obtain the target sample images. That is, the target number of sample images with small loss parameter values in the plurality of sample images are determined as the target sample images.

In some embodiments, the target number of the target sample images is calculated based on the number of times of iterative training, including:

2.1: acquiring a preset screening rate which is used to control the screening of the plurality of sample images;

2.2: calculating a proportion of the target sample images in the plurality of sample images based on the screening rate and the number of times of iterative training; and

2.3: calculating the target number of the target sample images based on the proportion and the number of the plurality of sample images.

In certain embodiments of the disclosure, a preset screening rate may be acquired first in the process of calculating the number of the target sample images. The screening rate is a proportion controlling the number of the target sample images selected from the plurality of sample images. According to the preset screening rate, the number of the target sample images may be the product of the number of the plurality of sample images and the preset screening rate at a later stage of model training. Therefore, after acquiring the preset screening rate, the proportion of the number of the target sample images selected in this iterative training in the number of the plurality of sample images may be calculated based on the preset screening rate and the number of times of iterative training. The target number of the target sample images may then be calculated further based on the proportion and the number of the plurality of sample images. In this way, the number of the target sample images can be controlled by setting the preset screening rate, so as to ensure that enough sample images with inaccurate label values can be screened out, and that enough sample images are guaranteed for model training.

Operation 105: Turn back to input the plurality of sample images into the updated at least two neural network models, separately, to obtain a fuzzy probability value set outputted by each sample image under the updated at least two neural network models and corresponding updated target images, and perform iterative training until the at least two neural network models converge to obtain the trained at least two neural network models.

In some embodiments, at operation 105, another plurality of sample images may be acquired and inputted into the updated neural network models for iteration. The another plurality of sample images are sample images that have not yet been used to train the at least two neural network models. For example, assuming that the training set has a total of 800 sample images, and assuming that 8 sample images are used in each iterative training, 8 unused sample images can be selected from the training set in each iterative training. In this way, if the training is iterated for 100 times, all sample images in the training set are used once, which is called an epoch. In some embodiments, the training lasts multiple epochs. As such, it may be said that each iteration of training uses a plurality of sample images corresponding to the iteration, which may be the same as or different from a plurality of sample images used in a different iteration of training.

The operations 102 to 104 above form a cycle in iterative training on the models. That is, performing fuzzy detection on a plurality of sample images using at least two neural networks, outputting a fuzzy probability value set corresponding to each sample image, calculating a loss parameter corresponding to each sample image based on the fuzzy probability value set of each sample image and a label value of each sample image, then determining target sample images based on the loss parameters of each of the sample images, and further training the at least two neural network models by using the target sample images, and updating these operations form a cycle or iteration of performing iterative training on the at least two neural network models.

After obtaining the updated at least two neural network models, the updated at least two neural network models may be substituted into operation 102 for a next cycle or iteration of training. That is, the plurality of sample images may be inputted into the updated at least two neural network models, separately, to obtain a fuzzy probability value set outputted by each sample image under the updated at least two neural network models. A new loss parameter corresponding to each sample image is then calculated again based on the fuzzy probability value set and the label value of each sample image. New target sample images are further determined based on the loss parameters of each of the sample images and the number of times of iterative training, and the updated at least two neural network models are re-trained and re-updated by using the new target sample images. In this manner, the at least two neural network models are iteratively trained until model parameters of the at least two neural network models converge to obtain the trained at least two neural network models.

Operation 106: Perform fuzzy detection on an image to be detected using the trained at least two neural network models to obtain a fuzzy detection result.

After the at least two neural network models are trained to obtain the trained at least two neural network models, fuzzy detection is performed on the image to be detected using the trained at least two neural network models to obtain the fuzzy detection result.

In some embodiments, fuzzy detection is performed on the image to be detected using the trained at least two neural network models to obtain the fuzzy detection result, including:

1: inputting the image to be detected into the trained at least two neural network models for fuzzy detection to obtain at least two fuzzy probability values; and

2: calculating an average value of the at least two fuzzy probability values to obtain a fuzzy probability corresponding to the image to be detected.

In certain embodiments of the disclosure, after the at least two neural network models are iteratively trained to obtain the trained at least two neural network models, the image to be detected is inputted into the trained at least two neural network models for fuzzy detection to obtain fuzzy probability values obtained by performing fuzzy detection on the image to be detected by each of the trained neural network models, that is, at least two fuzzy probability values are obtained. Then, the at least two fuzzy probability values are averaged to obtain a final fuzzy probability which is the detection result obtained by performing fuzzy detection on the image to be detected by the trained at least two neural network models. In some embodiments, a binary result of the fuzzy detection may be further determined based on the fuzzy probability values obtained by performing fuzzy detection on the image to be detected by the trained at least two neural network models, that is, determining whether the image to be detected is a blurry image or a non-blurry image based on the fuzzy probability values.

In certain embodiments, fuzzy detection is performed on the image to be detected using the trained at least two neural network models to obtain the fuzzy detection result, including:

A: acquiring prediction accuracy rates of the trained at least two neural network models, to obtain at least two prediction accuracy rates;

B: ranking the at least two prediction accuracy rates from high to low, and determine a neural network model with the highest prediction accuracy rate as a target neural network model; and

C: inputting the image to be detected into the target neural network model for fuzzy detection to obtain a fuzzy probability corresponding to the image to be detected.

In certain embodiments of the disclosure, after the at least two neural network models are trained to obtain the trained at least two neural network models, it is unnecessary to use all the trained neural network models for image detection on the image to be detected. Instead, the model prediction accuracy rate of each neural network model in the trained at least two neural network models are acquired, and then a neural network model with the highest prediction accuracy is determined as the target neural network model. Finally, fuzzy detection is performed on the image to be detected using the target neural network model to obtain the fuzzy probability value outputted from the target neural network, and the fuzzy probability value outputted from the target neural network is determined as the detection result of the fuzzy detection on the image to be detected.

According to the description above, it can be seen that the image detection method discussed herein acquires training sample data which includes a plurality of sample images and label information corresponding to each of the sample images. Each sample image is inputted into at least two neural network models, separately, to obtain a fuzzy probability value set outputted by each sample image under the at least two neural network models. A loss parameter corresponding to each sample image is calculated based on the fuzzy probability value set of each sample image and label information corresponding to each sample image. Target sample images are selected from the plurality of sample images based on a distribution of loss parameters corresponding to each of the sample images, and the at least two neural network models are updated based on the target sample images to obtain the updated at least two neural network models. Execution turns back to input the plurality of sample images into the updated at least two neural network models, separately, to obtain a fuzzy probability value set outputted by each sample image under the updated at least two neural network models and corresponding updated target images, and iterative training is performed until the at least two neural network models converge to obtain the trained at least two neural network models. Fuzzy detection is performed on an image to be detected using the trained at least two neural network models to obtain a fuzzy detection result. In this way, the effect of model training is improved by screening noise samples in training samples with multi-model collaboration, thereby improving the accuracy rate of image detection.

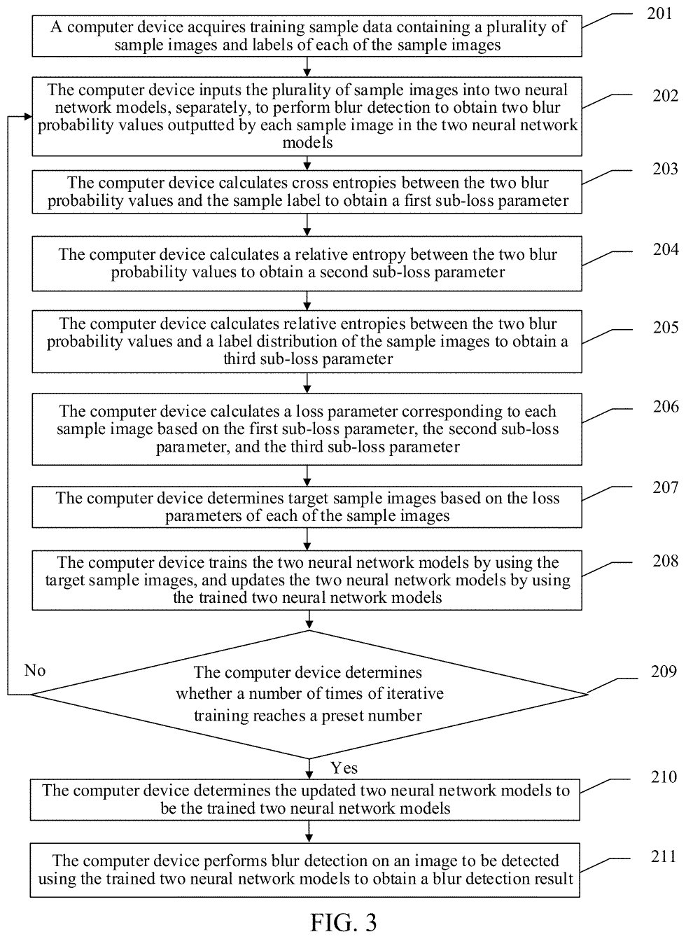

Accordingly, the disclosure will further describe in detail certain embodiments of the image detection method in the context of a computer device which may be a terminal or a server. FIG. 3 shows another schematic flowchart of an image detection method according to an embodiment of the disclosure, the method including:

Operation 201: The computer device acquires training sample data containing a plurality of sample images and labels of each of the sample images.

As described in the preceding embodiments, the labels corresponding to the sample images in the sample data for training the image detection models are those manually marked, and the labels of the sample images may be binary blur labels of the sample images herein. An image blur cannot be accurately marked with a binary label which simply refers to being blurred or not blurred, and the image blur may be in an intermediate state such as slight blur or partial blur. In certain embodiments of the disclosure, an image blur refers to a case where part or all of the content of the image cannot be identified due to the image being fuzzy. Therefore, marking the blur state of a sample image by using a simple binary label will make the label information of the sample image inaccurate. In order to solve the above technical problem that label information of a sample image may be inaccurate due to the use of a simple binary label to mark the blur state of the sample image, which may further result in inaccurate detection results of the trained image detection models, an image detection method may be provided, certain embodiments of which are described in further detail below.

In certain embodiments of the disclosure, the detection models are still trained by using sample images having binary blur labels. Therefore, training sample data is acquired first, and the training sample data includes a plurality of sample images and binary blur labels corresponding to each of the sample images. The binary blur label of a sample image refers to the sample image being a blurred image or not. When the sample image is a blurred image, the binary label of the sample image is 1. When the sample image is not a blurred image, the binary label of the sample image is 0.

Operation 202: The computer device inputs the plurality of sample images into two neural network models, separately, to perform blur detection to obtain two blur probability values outputted by each sample image in the two neural network models.

In certain embodiments of the disclosure, a multi-model collaborative training method can be used to train models for image blur detection. Since different neural network models have different decision boundaries, specifically, the parameters of the neural network models are initialized randomly each time the training is started. Therefore, different models have different capabilities to eliminate noise samples (that is, samples with inaccurate labels), and then multi-model collaborative training may well inherit advantages of the models and complement each other, so as to improve the capability of screening out the noise samples. Specifically, the multiple models may be two neural network models, three neural network models, or a greater number of neural network models. In certain embodiments of the disclosure, the collaborative training using two neural network models is described in detail as an example.

After acquiring a plurality of sample images and binary blur labels of each of the sample images, the plurality of sample images are inputted into two neural network models, separately, to obtain two blur probability values outputted by each sample image in the two neural network models. The two neural network models can be separately tagged as a first neural network model and a second neural network model. The blur probability value outputted from the first neural network model can be tagged as p1, and the blur probability value outputted from the second neural network model can be tagged as p2.

Operation 203: The computer device calculates cross entropies between the two blur probability values and the sample label to obtain a first sub-loss parameter.

After determining the blur probability values outputted by each sample image under the two neural network models, the cross entropies corresponding to each sample image is calculated by using the blur probability values of each sample image and the sample label, and the calculation formula is specifically as follows:

Lc1=−[y*log p1+(1−y)*log(1−p1)]

Lc2=−[y*log p2+(1−y)*log(1−p2)]

Lc1 is a cross entropy corresponding to the first neural network model; y is a label value corresponding to the sample image, that is, 0 or 1; p1 is a blur probability value obtained by the first neural network performing blur detection on the sample image. Lc2 is a cross entropy corresponding to the second neural network model; p2 is a blur probability value obtained by the second neural network performing blur detection on the sample image.

Then, the calculated two cross entropies are summed to obtain the first sub-loss parameter, and the calculation formula is as follows:

Lc=Lc1+Lc2

Lc is the calculated first sub-loss parameter, also referred to as a classification loss.

Operation 204: The computer device calculates a relative entropy between the two blur probability values to obtain a second sub-loss parameter.

As previously stated, the relative entropy may also be referred to as KL divergence. When the relative entropy between two blur probability values is calculated, the KL divergence between the two blur probability values is calculated, and the formula is specifically as follows:

$${L}_{reg} = K L ( p 1 \vert \vert p 2 ) = p 1 * log \frac{p 1}{p 2}$$

L_{reg} is the relative entropy between the two blur probability values, that is, the second sub-loss parameter to be calculated, also referred to as a cross-regular loss. A purpose of calculating the cross-regular loss is to constrain the probability distribution similarity between the blur probability values outputted from the two models, with an expectation that as the model training progresses, the probability values outputted for the same sample image under the two models may approach each other.

Since only two neural network models are taken as an example for explanation herein, there is only one relative entropy. If a plurality of neural network models are used for collaborative training, relative entropies may be calculated between every two blur probability values outputted from the neural network models, and the calculated plurality of relative entropies are summed to determine the second sub-loss parameter. Specifically, when there is a third neural network model, for example, a blur probability value outputted from the third neural network model performing blur detection on the sample image is p3, so relative entropies between p1 and p3 and between p2 and p3 are also calculated, and then the second sub-loss parameter is obtained by summing the three relative entropies.

Operation 205: The computer device calculates relative entropies between the two blur probability values and a label distribution of the sample images to obtain a third sub-loss parameter.

The label distribution of the sample images is a distribution of label values of the plurality of sample images. Specifically, when there are a total of 100 sample images, for example, of which 40 have a label value of 1 and 60 have a label value of 0, it may be determined that a ratio between blurred images and normal images is 4:6 in the 100 sample images, so the label distribution of the sample images can be obtained as Pₚᵣᵢₒᵣ=[0.4,0.6]. Then the cross entropies between the two blur probability values and the label distribution of the sample images are calculated, and the calculation formula is specifically as follows:

Lₚ₁=−Pₚᵣᵢₒᵣ*log p1

Lₚ₂=−Pₚᵣᵢₒᵣ*log p2

Lₚ₁ is a cross entropy corresponding to the first neural network model, and Lₚ₂ is a cross entropy corresponding to the second neural network model.

Then, the third sub-loss parameter can be further calculated, and the calculation formula is as follows:

Lₚ=Lₚ₁+Lₚ₂

Lₚ is the third sub-loss parameter, also referred to as a prior loss. A purpose of adding a prior loss is to expect that as the model training progresses, the distribution of probability values outputted from the two models may constantly approach the distribution of artificial label values.

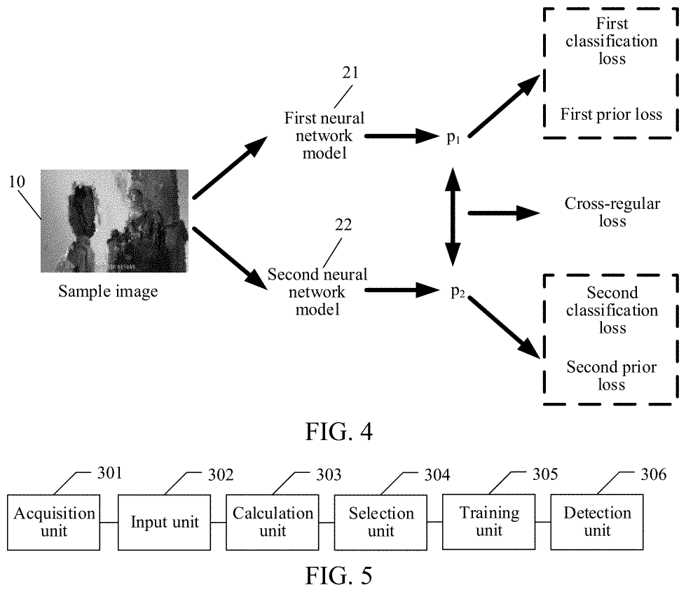

FIG. 4 shows a schematic diagram of a loss parameter calculation framework of sample images according to an embodiment of the disclosure. A first blur probability value p1 is outputted from the first neural network model 21 performing detection on the sample image 10, and a second blur probability value p2 is outputted from the second neural network model 22 performing detection on the sample image 10. Then, a first classification loss and a first prior loss are calculated based on the first blur probability value p1, and a second classification loss and a second prior loss are calculated based on the second blur probability value p2. A cross-regular loss is calculated based on the first blur probability value p1 and the second blur probability value p2. Finally, weighted summation is performed on the first classification loss, the first prior loss, the second classification loss, the second prior loss, and the cross-regular loss to obtain a loss parameter corresponding to the sample image.

Operation 206: The computer device calculates a loss parameter corresponding to each sample image based on the first sub-loss parameter, the second sub-loss parameter, and the third sub-loss parameter.

After the classification loss, the cross-regular loss, and the prior loss corresponding to each sample image are calculated, weighted summation may be performed on them to obtain the loss parameter corresponding to each sample image. The calculation formula is specifically as follows:

L=Lc+αL_{reg}+βLₚ

α is a weight coefficient for controlling the cross-regular loss, and β is a weight coefficient for controlling the prior loss. The above loss parameters are then used as end-to-end training loss parameters of models to guide model training.

Operation 207: The computer device determines target sample images based on the loss parameters of each of the sample images.

After the loss parameters corresponding to each of the sample images are calculated, the sample images may be screened based on the loss parameters of the sample images, so as to eliminate samples with large amounts of noise (with inaccurate label values). In general, the samples that output greater loss parameter values may have greater (larger) sample noise, so certain sample images with greater loss parameters may be eliminated, and target sample images with smaller loss parameter values may be used for model training.

The proportion of the target sample images may be calculated with the following formula:

$$R ( t ) = 1 - min \{ \frac{t}{{T}_{k}} τ , τ \}$$

R (t) is the proportion of the target sample images in the plurality of sample images, t is the number of times of iteration of current training, Tₖ is a super-parameter for controlling a corresponding screening rate with the number of times of iteration of current training being t, and i is a preset screening rate.

According to the calculation formula for R(t), in the initial stage of iterative training where t is small, the value R(t) is great, and many sample images will be used to train two neural network models, and the screening proportion of noise samples is small. As the iterative training enters a later stage where t becomes greater, R(t) becomes smaller, the number of target samples also becomes smaller, and the screening proportion of noise samples becomes greater, so that most of the noise sample images will be eliminated.

After the proportion R(t) of the target images in the plurality of sample images is calculated, R(t) of sample images with the smallest loss parameters are selected as the target sample images from the plurality of sample images according to the proportion.

Operation 208: The computer device trains the two neural network models by using the target sample images, and updates the two neural network models by using the trained two neural network models.

After the target sample images for training are determined, the target sample images and the corresponding label values thereof are used to train the two neural network models, so as to update the model parameters of the two neural network models to obtain the updated two neural network models. Then the updated two neural network models are used for further training and updating.

Operation 209: The computer device determines whether the number of times of iterative training reaches a preset number.

After each update of the two neural network models, the computer device may determine the number of times of iterative training so as to determine whether a preset number of times of iterative training is reached. If the preset number is not reached, execution turns back to operation 202 where the updated two neural network models are used for blur re-detection on each of the sample images so as to obtain new blur probability values. New loss parameters of each of the sample images are further calculated based on the new blur probability values. Then, new target sample images are re-determined, and the new target sample images are used to re-train and re-update the updated two neural network models.

Operation 210: The computer device determines the updated two neural network models to be the trained two neural network models.

If the number of times of iterative training reaches the preset number, the two neural network models finally obtained are determined to be the final trained neural network models.

Operation 211: The computer device performs blur detection on an image to be detected using the trained two neural network models to obtain a blur detection result.

After the trained two neural network models are determined, the trained two neural network models can be used to perform blur detection on the image to be detected. Specifically, a target neural network model with better detection results can be determined from the trained two neural network models to detect the image to be detected. The detection effects of the trained two neural network models can be verified by using images marked with accurate labels.

Blur detection is performed on the image to be detected using the target neural network model, where a blur probability value of the image to be detected is inputted, and then a binary blur result of the image to be detected is further determined based on the blur probability value, that is, the image to be detected is a blurred image or not. Specifically, the binary blur result of the image to be detected can be determined according to the comparison result between the blur probability value outputted from the detection and the preset probability value. For example, when the blur probability value outputted from the target neural network model performing blur detection on the image to be detected is 0.9, and the preset blur probability value is 0.95, the image to be detected is determined to be a blurred image.

According to the description above, it can be seen that the image detection method provided in various embodiments of the disclosure acquires training sample data which includes a plurality of sample images and label information corresponding to each of the sample images. Each sample image is inputted into at least two neural network models, separately, to obtain a fuzzy probability value set outputted by each sample image under the at least two neural network models. A loss parameter corresponding to each sample image is calculated based on the fuzzy probability value set of each sample image and label information corresponding to each sample image. Target sample images are selected from the plurality of sample images based on a distribution of loss parameters corresponding to each of the sample images, and the at least two neural network models are updated based on the target sample images to obtain the updated at least two neural network models. Execution turns back to input the plurality of sample images into the updated at least two neural network models, separately, to obtain a fuzzy probability value set outputted by each sample image under the updated at least two neural network models and corresponding updated target images, and iterative training is performed until the at least two neural network models converge to obtain the trained at least two neural network models. Fuzzy detection is performed on an image to be detected using the trained at least two neural network models to obtain a fuzzy detection result. In this way, the effect of model training is improved by screening noise samples in training samples with multi-model collaboration, thereby further improving the accuracy rate of image detection.

In order to better implement the method above, embodiments of the present disclosure further provide an image detection apparatus that may be integrated into a terminal.

For example, FIG. 5 is a structural schematic diagram of an image detection apparatus according to an embodiment of the disclosure. The image detection apparatus may include an acquisition unit 301, an input unit 302, a calculation unit 303, a selection unit 304, a training unit 305, and a detection unit 306.

The acquisition unit 301 is configured to acquire training sample data which includes a plurality of sample images and label information corresponding to each of the sample images.

The input unit 302 is configured to input each sample image into at least two neural network models, separately, to obtain a fuzzy probability value set outputted by each sample image under the at least two neural network models.

The calculation unit 303 is configured to calculate, based on the fuzzy probability value set of each sample image and label information corresponding to each sample image, a loss parameter corresponding to each sample image.

The selection unit 304 is configured to select, based on a distribution of loss parameters corresponding to each of the sample images, target sample images from the plurality of sample images, and update, based on the target sample images, the at least two neural network models to obtain the updated at least two neural network models.

The training unit 305 is configured to turn back to input the plurality of sample images into the updated at least two neural network models, separately, to obtain a fuzzy probability value set outputted by each sample image under the updated at least two neural network models and corresponding updated target images, and perform iterative training until the at least two neural network models converge to obtain the trained at least two neural network models.

The detection unit 306 is configured to perform fuzzy detection on an image to be detected using the trained at least two neural network models to obtain a fuzzy detection result.

In some embodiments, the calculation unit includes the following sub-units.

A first calculation sub-unit is configured to calculate first cross entropies between each of fuzzy probability values in the fuzzy probability value set corresponding to each sample image and corresponding label information.

A second summation sub-unit is configured to sum the calculated first cross entropies to obtain a first sub-loss parameter corresponding to each sample image.

A determination sub-unit is configured to determine the loss parameter corresponding to each sample image based on the first sub-loss parameter corresponding to each sample image.

In certain embodiments, the image detection apparatus may further include the following sub-units.

A second calculation sub-unit is configured to calculate relative entropies between every two fuzzy probability values in the fuzzy probability value set corresponding to each sample image.

A second summation sub-unit is configured to sum the relative entropies to obtain a second sub-loss parameter corresponding to each sample image.

The determination sub-unit is further configured to:

perform weighted summation on the first sub-loss parameter and the second sub-loss parameter corresponding to each sample image to obtain the loss parameter corresponding to each sample image.

In certain embodiments, the image detection apparatus may further include the following sub-units.

A first acquisition sub-unit is configured to acquire probability distribution information of label information in sample data, and generate a corresponding feature vector based on the probability distribution information.

A third calculation sub-unit is configured to calculate second cross entropies between the feature vector and the fuzzy probability value set corresponding to each sample image.

A third summation sub-unit is configured to sum the calculated second cross entropies to obtain a third sub-loss parameter corresponding to each sample image.

The determination sub-unit is further configured to:

perform weighted summation on the first sub-loss parameter, the second sub-loss parameter, and the third sub-loss parameter corresponding to each sample image to obtain the loss parameter corresponding to each sample image.

In some embodiments, the selection unit includes the following sub-units.

A second acquisition sub-unit is configured to acquire a number of times of iterative training on the at least two neural network models.

A fourth calculation sub-unit is configured to calculate a target number of the target sample images based on the number of times of iterative training.

A selection sub-unit is configured to select the target number of sample images in an order of loss parameters being from small to great to obtain the target sample images.

In some embodiments, the fourth calculation sub-unit includes the following modules.

An acquisition module is configured to acquire a preset screening rate which is used to control the screening of the plurality of sample images.

A first calculation module is configured to calculate a proportion of the target sample images in the plurality of sample images based on the screening rate and the number of times of iterative training.

A second calculation module is configured to calculate the target number of the target sample images based on the proportion and the number of the plurality of sample images.

In some embodiments, the detection unit includes the following sub-units.

A first input sub-unit is configured to input the image to be detected into the trained at least two neural network models for fuzzy detection to obtain at least two fuzzy probability values.

A fifth calculation sub-unit is configured to calculate an average value of the at least two fuzzy probability values to obtain a fuzzy probability corresponding to the image to be detected.

In some embodiments, the detection unit includes the following sub-units.

A third acquisition sub-unit is configured to acquire prediction accuracy rates of the trained at least two neural network models, and obtain at least two prediction accuracy rates.

A ranking sub-unit is configured to rank the at least two prediction accuracy rates from high to low, and determine a neural network model with the highest prediction accuracy rate as a target neural network model.

A detection sub-unit is configured to input the image to be detected into the target neural network model for fuzzy detection to obtain a fuzzy probability corresponding to the image to be detected.

In specific implementations, the units above may be implemented as independent entities or may be implemented in any combination as the same or similar entities. The units above may be implemented as modules of software code executing on at least one processor. The specific implementations of the units above may refer to previous method embodiments and will not be described in detail herein.

According to the description above, it can be seen that in an image detection method according to various embodiments of the disclosure, the acquisition unit 301 acquires training sample data which includes a plurality of sample images and label information corresponding to each of the sample images. The input unit 302 inputs each sample image into at least two neural network models, separately, to obtain a fuzzy probability value set outputted by each sample image under the at least two neural network models. The calculation unit 303 calculates, based on the fuzzy probability value set of each sample image and label information corresponding to each sample image, a loss parameter corresponding to each sample image. The selection unit 304 selects, based on a distribution of loss parameters corresponding to each of the sample images, target sample images from the plurality of sample images, and updates, based on the target sample images, the at least two neural network models to obtain the updated at least two neural network models. The training unit 305 turns back to input the plurality of sample images into the updated at least two neural network models, separately, to obtain a fuzzy probability value set outputted by each sample image under the updated at least two neural network models and corresponding updated target images, and performs iterative training until the at least two neural network models converge to obtain the trained at least two neural network models. The detection unit 306 performs fuzzy detection on an image to be detected using the trained at least two neural network models to obtain a fuzzy detection result. In this way, the effect of model training is improved by screening noise samples in training samples with multi-model collaboration, thereby further improving the accuracy rate of image detection.

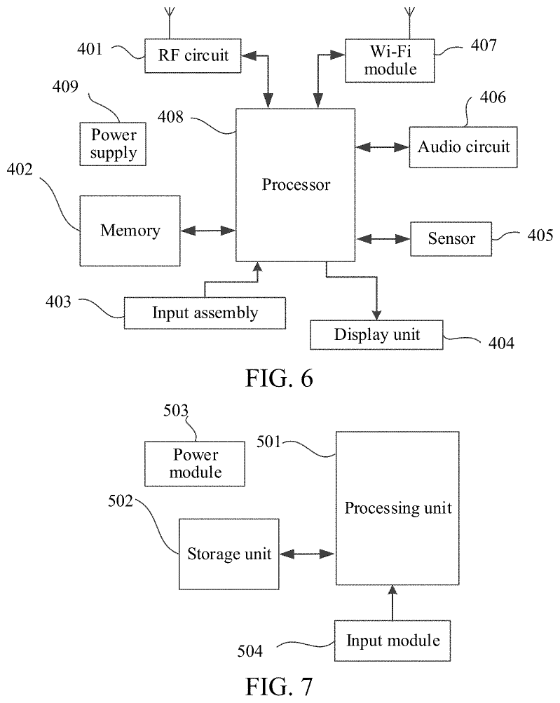

Certain embodiments of the disclosure may further provide a computer device that may be a terminal. As shown in FIG. 6, the terminal may include a Radio Frequency (RF) circuit 401, a memory 402 including one or more computer-readable storage media, an input assembly 403, a display unit 404, a sensor 405, an audio circuit 406, a Wireless Fidelity (WiFi) module 407, a processor 408 including one or more processing cores, a power supply 409, and other components. It is to be understood by those skilled in the art that the terminal configuration shown in FIG. 6 is not intended to limit the terminal and the terminal may include more or fewer components than shown, a combination of some components, or a different arrangement of components.

The memory 402 may be configured to store software programs and modules, and the processor 408 executes the software programs and modules stored in the memory 402 to perform various functional applications and information interactions.

In the illustrated embodiment, the processor 408 in the terminal will load executable files corresponding to processes of one or more applications into the memory 402 according to the following instructions, and the processor 408 runs the applications stored in the memory 402 to realize various functions.

Training sample data is acquired which includes a plurality of sample images and label information corresponding to each of the sample images. Each sample image is inputted into at least two neural network models, separately, to obtain a fuzzy probability value set outputted by each sample image under the at least two neural network models. A loss parameter corresponding to each sample image is calculated based on the fuzzy probability value set of each sample image and label information corresponding to each sample image. Target sample images are selected from the plurality of sample images based on a distribution of loss parameters corresponding to each of the sample images, and the at least two neural network models are updated based on the target sample images to obtain the updated at least two neural network models. Execution turns back to input the plurality of sample images into the updated at least two neural network models, separately, to obtain a fuzzy probability value set outputted by each sample image under the updated at least two neural network models and corresponding updated target images, and iterative training is performed until the at least two neural network models converge to obtain the trained at least two neural network models. Fuzzy detection is performed on an image to be detected using the trained at least two neural network models to obtain a fuzzy detection result.

The computer device provided in certain embodiments of the disclosure relates to the same or similar idea as the method in the above embodiments, and the specific implementations of the operations above may refer to the previous embodiments and will not be described in detail herein.

Embodiments of the disclosure further provide a computer device that may be a server. FIG. 7 is a structural schematic diagram of the computer device according to an embodiment of the disclosure. Specifically, the computer device may include a processing unit 501 of one or more processing cores, a storage unit 502 of one or more storage media, a power module 503, an input module 504, and other components. It is to be understood by those skilled in the art that the computer device configuration shown in FIG. 7 is not intended to limit the computer device and the computer device may include more or fewer components than shown, a combination of some components, or a different arrangement of components.

The processing unit 501 is a control center of the computer device. It connects various parts of the entire computer device with various interfaces and lines, and performs various functions of the computer device and processes data by running or executing software programs and/or modules stored in the storage unit 502 and calling data stored in the storage unit 502, thus monitoring the computer device as a whole. Alternatively, the processing unit 501 may include one or more processing cores. Preferably, the processing unit 501 may integrate an application processor which primarily handles operating systems, user interfaces, and applications, and a modem processor which primarily handles wireless communication. It is to be understood that the modem processor described above need not be integrated into the processing unit 501.

The storage unit 502 may be configured to store software programs and modules, and the processing unit 501 runs the software programs and modules stored in the storage unit 502 to perform various functional applications and data processing. The storage unit 502 may mainly include a program storage area that may store operating systems, applications required by at least one function (such as a sound playback function, an image playback function, and web page access) and a data storage area that may store data and the like created according to the use of the computer device. In addition, the storage unit 502 may include a high speed random access memory and may also include a non-volatile memory, such as at least one magnetic disk memory device, flash memory device, or other non-volatile solid-state memory devices. Accordingly, the storage unit 502 may further include a memory controller to provide access of the processing unit 501 to the storage unit 502.

The computer device further includes the power module 503 for supplying power to various components. Preferably, the power module 503 may be logically connected to the processing unit 501 through a power management system, so as to realize functions of managing charging, discharging, and power consumption through the power management system. The power module 503 may further include any of one or more DC or AC power supplies, a recharging system, a power failure detection circuit, a power converter or inverter, a power status indicator, and the like.

The computer device may further include the input module 504 operable to receive inputted digital or character information and to generate keyboard, mouse, joystick, optical, or trackball signal inputs related to user settings and function controls.

Although not shown, the computer device may further include a display unit and the like, which will not be described in detail herein. In the illustrated embodiment, the processing unit 501 in the computer device may load executable files corresponding to processes of one or more applications into the storage unit 502 according to the following instructions, and the processing unit 501 runs the applications stored in the storage unit 502 to realize following functions.

Training sample data is acquired which includes a plurality of sample images and label information corresponding to each of the sample images. Each sample image is inputted into at least two neural network models, separately, to obtain a fuzzy probability value set outputted by each sample image under the at least two neural network models. A loss parameter corresponding to each sample image is calculated based on the fuzzy probability value set of each sample image and label information corresponding to each sample image. Target sample images are selected from the plurality of sample images based on a distribution of loss parameters corresponding to each of the sample images, and the at least two neural network models are updated based on the target sample images to obtain the updated at least two neural network models. Execution turns back to input the plurality of sample images into the updated at least two neural network models, separately, to obtain a fuzzy probability value set outputted by each sample image under the updated at least two neural network models and corresponding updated target images, and iterative training is performed until the at least two neural network models converge to obtain the trained at least two neural network models. Fuzzy detection is performed on an image to be detected using the trained at least two neural network models to obtain a fuzzy detection result.

The computer device provided in certain embodiments of the disclosure relates to the same or similar idea as the method in the above embodiments, and the specific implementations of the operations above may correspond to the previous embodiments and will not be described in detail herein.

It is to be understood by those of ordinary skill in the art that all or part of the operations in various methods of the above embodiments can be completed through instructions or through controlling related hardware by instructions. The instructions may be stored in a computer-readable storage medium and loaded and executed by a processor.

Therefore, the embodiments of the present disclosure provide a non-transitory computer-readable storage medium storing a plurality of instructions therein, the instructions being able to be loaded by a processor to execute the operations in any of the methods provided in embodiments of the present disclosure. For example, the instructions may execute the following operations:

Acquire training sample data which includes a plurality of sample images and label information corresponding to each of the sample images. Input each sample image into at least two neural network models, separately, to obtain a fuzzy probability value set outputted by each sample image under the at least two neural network models. Calculate, based on the fuzzy probability value set of each sample image and label information corresponding to each sample image, a loss parameter corresponding to each sample image. Select, based on a distribution of loss parameters of each corresponding to the sample images, target sample images from the plurality of sample images, and update, based on the target sample images, the at least two neural network models to obtain the updated at least two neural network models. Turn back to input the plurality of sample images into the updated at least two neural network models, separately, to obtain a fuzzy probability value set outputted by each sample image under the updated at least two neural network models and corresponding updated target images, and perform iterative training until the at least two neural network models converge to obtain the trained at least two neural network models. Perform fuzzy detection on an image to be detected using the trained at least two neural network models to obtain a fuzzy detection result. The specific implementations of the operations above may correspond to the previous embodiments and will not be described in detail herein.

The computer-readable storage medium may include: ROM (Read Only Memory), RAM (Random Access Memory), magnetic or optical disks, etc.

Since the instructions stored in the computer-readable storage medium can perform the operations in any of the methods provided in various embodiments of the present disclosure, the advantages that can be realized by any of the methods provided in the various embodiments of the present disclosure can be realized, which are described in detail in the preceding embodiments and will not be described in detail herein.

According to one aspect of the disclosure, there is provided a computer program product or computer program including computer instructions stored in a storage medium. A processor of a computer device reads the computer instructions from the storage medium, and the processor executes the computer instructions to cause the computer device to perform the method provided in the alternative implementations of FIG. 2 or 3 described above.

An image detection method and apparatus, a computer-readable storage medium, and a computer device provided according to various embodiments of the present disclosure are described in detail above. While the principles and implementations of the present disclosure are illustrated herein with specific examples, the description of the embodiments above is merely intended to help understand the methods and core ideas of the present disclosure. Meanwhile, for those skilled in the art, there will be changes in specific implementations and scope on the basis of ideas of the present disclosure. In summary, the above contents are not construed as limiting the present disclosure.

What is claimed is:

1. An image detection method performed by a computer device, the method comprising:
iteratively training a plurality of neural network models until the plurality of neural network models converge, to obtain a plurality of trained neural network models, each iteration of training comprising:
for each sample image in a plurality of sample images corresponding to the iteration:
separately inputting the sample image into the plurality of neural network models, to obtain a fuzzy probability value set of the sample image, the fuzzy probability value set comprising fuzzy probability values outputted from each of the plurality of neural network models, and
calculating, based on the fuzzy probability value set and preset label information of the sample image, a loss parameter of the sample image,
selecting, based on a distribution of loss parameters of the plurality of sample images, target sample images from the plurality of sample images, and
updating, based on the target sample images, the plurality of neural network models; and
performing fuzzy detection on an image to be detected by at least one trained neural network model of the plurality of trained neural network models, to obtain a fuzzy detection result.

2. The method according to claim 1, wherein the calculating of the loss parameter of the sample image comprises:
calculating first cross entropies between the preset label information and each fuzzy probability value in the fuzzy probability value set of the sample image;
summing the calculated first cross entropies to obtain a first sub-loss parameter of the sample image; and
determining the loss parameter corresponding to the sample image based on the first sub-loss parameter of the sample image.

3. The method according to claim 2, wherein the calculating of the loss parameter of the sample image further comprises:
calculating relative entropies between each pair of fuzzy probability values in the fuzzy probability value set of the sample image; and
summing the relative entropies to obtain a second sub-loss parameter corresponding to the sample image,
wherein the loss parameter of the sample image is determined as a weighted summation of at least the first sub-loss parameter and the second sub-loss parameter.

4. The method according to claim 2, wherein the calculating of the loss parameter of the sample image further comprises:
acquiring probability distribution information of preset label information of the plurality of sample images;
generating a corresponding feature vector based on the probability distribution information;
calculating second cross entropies between the feature vector and the fuzzy probability value set corresponding to the sample image; and
summing the calculated second cross entropies to obtain a third sub-loss parameter of the sample image,
wherein the loss parameter of the sample image is determined as a weighted summation of at least the first sub-loss parameter and the third sub-loss parameter.

5. The method according to claim 3, wherein the calculating of the loss parameter of the sample image further comprises:
acquiring probability distribution information of preset label information of the plurality of sample images;
generating a feature vector based on the probability distribution information;
calculating second cross entropies between the feature vector and the fuzzy probability value set corresponding to the sample image; and
summing the calculated second cross entropies to obtain a third sub-loss parameter of the sample image,
wherein the loss parameter of the sample image is determined as a weighted summation of at least the first sub-loss parameter, the second sub-loss parameter, and the third sub-loss parameter.

6. The method according to claim 1, wherein the selecting of the target sample images from the plurality of sample images comprises:
acquiring a current number of iterations of training on the plurality of neural network models;
calculating a target number based on the current number of iterations; and
selecting the target number of sample images in an order of loss parameters from small to large to obtain the target sample images.

7. The method according to claim 6, wherein the calculating of the target number comprises:
acquiring a preset screening rate which is used to control the screening of the plurality of sample images;
calculating a proportion of the target sample images in the plurality of sample images based on the screening rate and the current number of iterations; and
calculating the target number of the target sample images based on the proportion and a number of the plurality of sample images.

8. The method according to claim 1, wherein the performance of the fuzzy detection comprises:
separately performing fuzzy detection on the image to be detected by each of the plurality of trained neural network models to thereby obtain, for each of the trained plurality of neural network models, a fuzzy probability value, and
obtaining an average value of the obtained fuzzy probability values as a fuzzy probability corresponding to the image to be detected.

9. The method according to claim 1, wherein the performance of the fuzzy detection comprises:
acquiring prediction accuracy rates of each of the plurality of trained neural network models,
ranking the prediction accuracy rates, and
performing the fuzzy detection by a neural network model with a highest prediction accuracy rate according to the ranking.

10. An image detection apparatus, comprising:
at least one processor; and
at least one non-volatile memory having stored thereon a plurality of neural network models and a computer program, wherein the computer program, when executed by the at least one processor, causes the at least one processor to perform operations of:
iteratively training the plurality of neural network models until the plurality of neural network models converge, to obtain a plurality of trained neural network models, each iteration of training comprising:
for each sample image in a plurality of sample images corresponding to the iteration:
separately inputting the sample image into the plurality of neural network models, to obtain a fuzzy probability value set of the sample image, the fuzzy probability value set comprising fuzzy probability values outputted from each of the plurality of neural network models, and
calculating, based on the fuzzy probability value set and preset label information of the sample image, a loss parameter of the sample image,
selecting, based on a distribution of loss parameters of the plurality of sample images, target sample images from the plurality of sample images, and
updating, based on the target sample images, the plurality of neural network models; and
performing fuzzy detection on an image to be detected by at least one trained neural network model of the plurality of trained neural network models, to obtain a fuzzy detection result.

11. The apparatus according to claim 10, wherein the computer program causes the at least one processor to calculate the loss parameter of the sample image by:
calculating first cross entropies between the preset label information and each fuzzy probability value in the fuzzy probability value set of the sample image;
summing the calculated first cross entropies to obtain a first sub-loss parameter of the sample image; and
determining the loss parameter corresponding to the sample image based on the first sub-loss parameter of the sample image.

12. The apparatus according to claim 11, wherein the computer program further causes the at least one processor to calculate the loss parameter of the sample image by:
calculating relative entropies between each pair of fuzzy probability values in the fuzzy probability value set of the sample image; and
summing the relative entropies to obtain a second sub-loss parameter corresponding to the sample image,
wherein the loss parameter of the sample image is determined as a weighted summation of at least the first sub-loss parameter and the second sub-loss parameter.

13. The apparatus according to claim 11, wherein the computer program further causes the at least one processor to calculate the loss parameter of the sample image by:
acquiring probability distribution information of preset label information of the plurality of sample images;
generating a corresponding feature vector based on the probability distribution information;
calculating second cross entropies between the feature vector and the fuzzy probability value set corresponding to the sample image; and
summing the calculated second cross entropies to obtain a third sub-loss parameter of the sample image,
wherein the loss parameter of the sample image is determined as a weighted summation of at least the first sub-loss parameter and the third sub-loss parameter.

14. The apparatus according to claim 12, wherein the computer program further causes the at least one processor to calculate the loss parameter of the sample image by:
acquiring probability distribution information of preset label information of the plurality of sample images;
generating a feature vector based on the probability distribution information;
calculating second cross entropies between the feature vector and the fuzzy probability value set corresponding to the sample image; and
summing the calculated second cross entropies to obtain a third sub-loss parameter of the sample image,
wherein the loss parameter of the sample image is determined as a weighted summation of at least the first sub-loss parameter, the second sub-loss parameter, and the third sub-loss parameter.

15. The apparatus according to claim 10, wherein the computer program causes the at least one processor to select the target sample images from the plurality of sample images by:
acquiring a current number of iterations of training on the plurality of neural network models;
calculating a target number based on the current number of iterations; and
selecting the target number of sample images in an order of loss parameters from small to large to obtain the target sample images.

16. The apparatus according to claim 15, wherein the computer program causes the at least one processor to calculate the target number by:
acquiring a preset screening rate which is used to control the screening of the plurality of sample images;
calculating a proportion of the target sample images in the plurality of sample images based on the screening rate and the current number of iterations; and
calculating the target number of the target sample images based on the proportion and a number of the plurality of sample images.

17. The apparatus according to claim 10, wherein the computer program causes the at least one processor to perform the fuzzy detection by:
separately performing fuzzy detection on the image to be detected by each of the plurality of trained neural network models to thereby obtain, for each of the trained plurality of neural network models, a fuzzy probability value, and
obtaining an average value of the obtained fuzzy probability values as a fuzzy probability corresponding to the image to be detected.

18. The apparatus according to claim 10, wherein the computer program causes the at least one processor to perform the fuzzy detection by:
acquiring prediction accuracy rates of each of the plurality of trained neural network models,
ranking the prediction accuracy rates, and
performing the fuzzy detection by a neural network model with a highest prediction accuracy rate according to the ranking.

19. A non-transitory computer-readable storage medium storing a plurality of instructions thereon, the instructions being executable by at least one processor to perform operations of an image detection method comprising:
iteratively training a plurality of neural network models until the plurality of neural network models converge, to obtain a plurality of trained neural network models, each iteration of training comprising:
for each sample image in a plurality of sample images corresponding to the iteration:
separately inputting the sample image into the plurality of neural network models, to obtain a fuzzy probability value set of the sample image, the fuzzy probability value set comprising fuzzy probability values outputted from each of the plurality of neural network models, and
calculating, based on the fuzzy probability value set and preset label information of the sample image, a loss parameter of the sample image,
selecting, based on a distribution of loss parameters of the plurality of sample images, target sample images from the plurality of sample images, and
updating, based on the target sample images, the plurality of neural network models; and
performing fuzzy detection on an image to be detected by at least one trained neural network model of the plurality of trained neural network models, to obtain a fuzzy detection result.
